(19) United States
(12) Patent Application Publication
(10) Pub. No.: US 2024/0104795 A1
(43) Pub. Date: Mar. 28, 2024

(54) SYSTEM AND METHOD FOR COLOR PALETTE ANALYSIS AND CREATION

(71) Applicant: Susan JANECZKO, Glenn Dale, MD (US)

(72) Inventor: Susan JANECZKO, Glenn Dale, MD (US)

(21) Appl. No.: 18/316,298

(22) Filed: May 12, 2023

Related U.S. Application Data
(60) Provisional application No. 63/409,410, filed on Sep. 23, 2022.

(51) Int. Cl. G06T 11/00

(52) U.S. Cl. CPC G06T 11/001

(57) ABSTRACT

A system and method for color palette analysis and creation may be provided. The system and method for color palette analysis may include sending a user a color sample taking device. The user may take readings of fixed color areas such as skin, hair, or eye color. The fixed color readings may be used to determine a user's personalized color palette, which may include, for example, exact color matches and/or color harmony matches. The user may use their personalized color palette to, for example, select clothing, makeup, or other products.

### BACKGROUND

Proper color selection and coordination in cosmetics, clothing, jewelry, and other personal application can improve an individual's quality of life by enhancing or optimizing a person's appearance and improving social interactions, mental health, and personal or professional development. On the other hand, clashing colors or colors that don't complement a person's appearance may produce detrimental effects.

Systems and methods for creating color palettes exist; however, personalizing these systems to work with an individual's skin, eye, hair, or other natural fixed or partially fixed colors presents a challenge. Often, existing systems have a limited number of different palettes they select from or otherwise broadly categorize individual attribute colors and, therefore, may only generate partially flattering palettes. Systems and methods to create and use color palettes with standardized groupings miss the opportunity to produce a truly customized color palette based on each individual customer's attributes, which are highly variable. Further, methods for creating color palettes that rely on a photograph or other image for analysis as well as those that produce a visual color palette as a primary reference point suffer from serious inaccuracy as a result of color display limitations on electronic screens and/or the complexity of recreating colors using the printing or dyeing process.

Other existing systems rely on a subjective view of colors and how they look on an individual and rely on an “expert's” opinion either entirely or to supplement a broad categorization. These systems are more prone to mistakes and can also greatly increase the cost of getting a palette designed.

### SUMMARY

In an exemplary embodiment, a system and method for color palette analysis and creation may be provided. The system and method for color palette analysis may include sending a user a color sample taking device. The user may take readings of fixed color areas such as skin, hair, or eye color. The fixed color readings may be used to determine a user's personalized color palette, which may include, for example, perfect color matches and color harmony matches, such as complimentary colors. The fixed color readings may also be used to, for example, give color recommendations on contrast, balance, or any other color related concepts. The user may use their personalized color palette to, for example, select clothing, makeup, or other products.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Advantages of embodiments of the present invention will be apparent from the following detailed description of the exemplary embodiments. The following detailed description should be considered in conjunction with the accompanying figures in which:

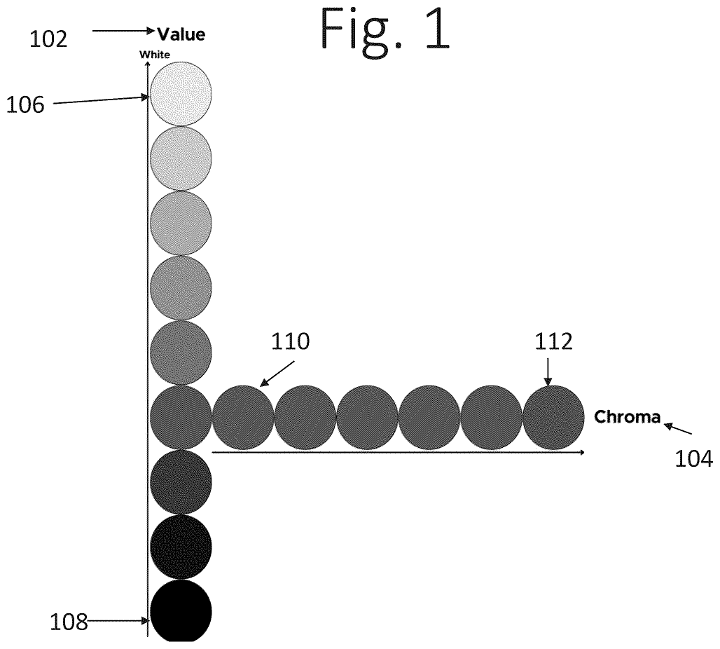

Exemplary FIG. 1 shows an exemplary value-chroma color graph.

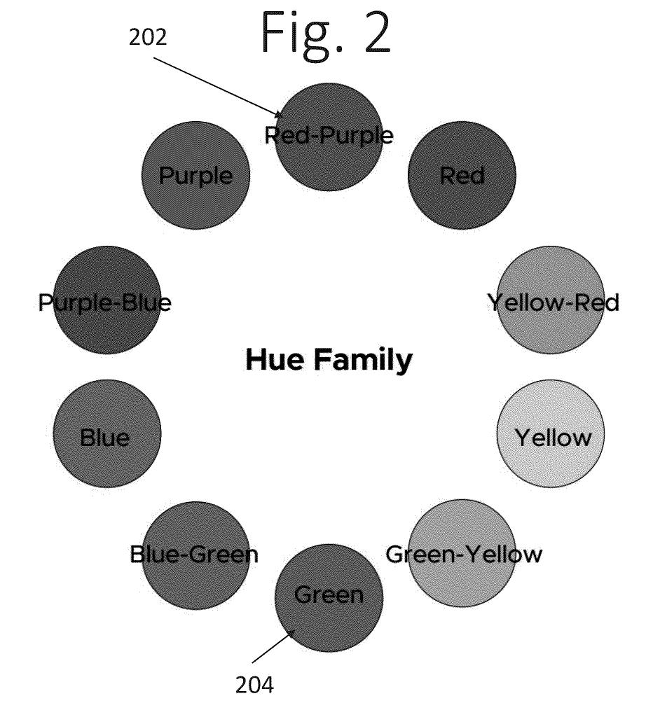

Exemplary FIG. 2 shown an exemplary color hue family wheel.

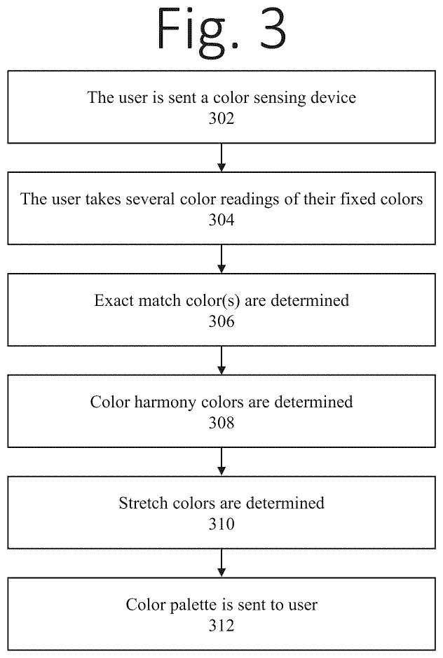

Exemplary FIG. 3 shows an exemplary process for creating a color palette.

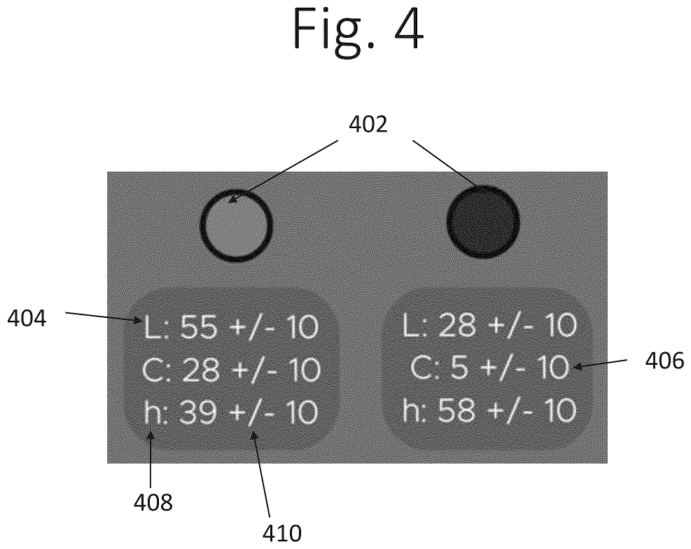

Exemplary FIG. 4 shows an exemplary perfect match guide.

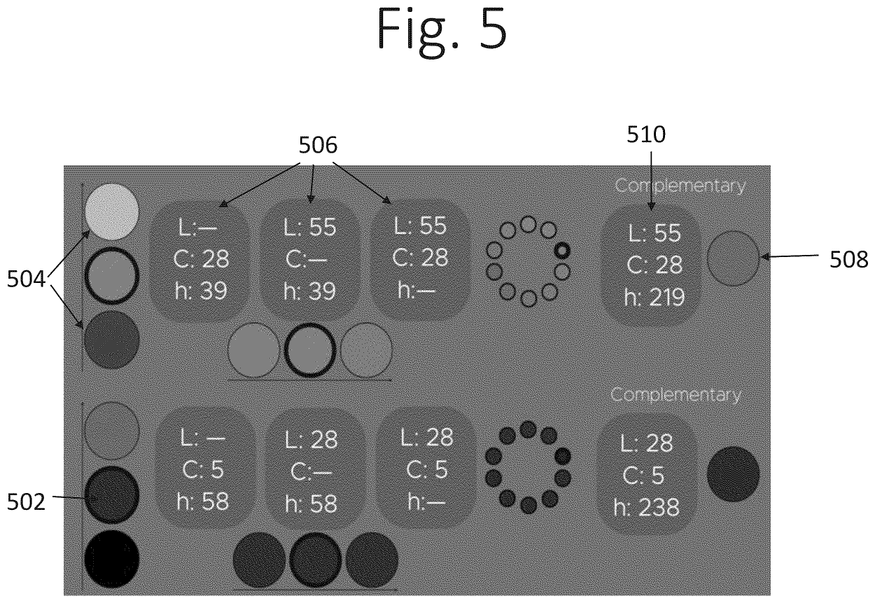

Exemplary FIG. 5 shows an exemplary color harmony guide.

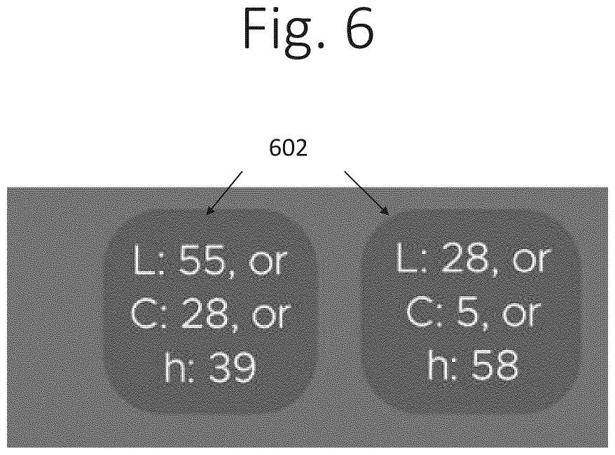

Exemplary FIG. 6 shows an exemplary fringe color guide.

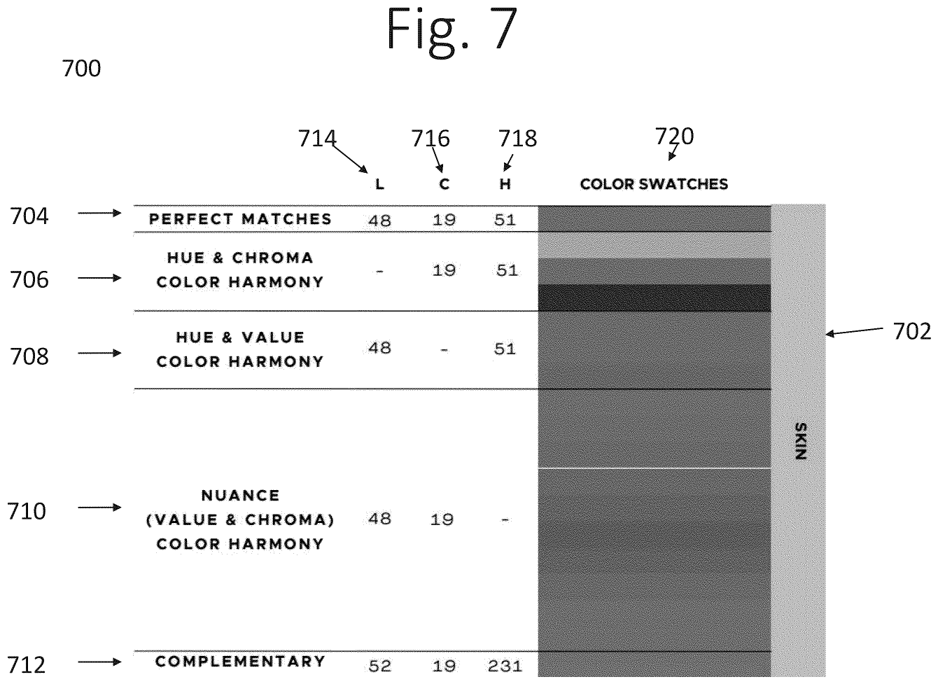

Exemplary FIG. 7 shows another exemplary color match guide.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage, or mode of operation.

As used herein a color's “hue” means the dominant color wavelength in the visible light spectrum, and may be defined, for example, on a circle divided into 360 degrees. A color's “value” is where the color falls on a scale of black to white with steps of gray in between, and may be defined, for example, on a scale from 1 to 100. A color's “chroma” is how clean the color is, for example, a color with low chroma will appear grayed or muted while a color with high chroma will appear strong and pure, and may, for example, start at 0 and terminate at various values depending on the hue of the color in question. Each of hue, value, and chroma may be notified by a numeric value.

Referring to exemplary FIG. 1, an exemplary value-chroma color graph 100 may include a value axis 102 and a chroma axis 104. The color graph 100 may show colors with high value 106, I.E. white or near white, or colors with low value 108, I.E. black or near black. The color graph 100 may further show colors with low chroma 110, or colors with high chroma 112.

Referring to exemplary FIG. 2, an exemplary color hue family wheel 200 may include a number of color hue groups. For example, there may be a red-purple color hue group 202. The position of a color hue group on the chart may correspond to the color hue parameter given to that color hue, for example, if the red-purple group 202 is at the top of the chart it may have a corresponding parameter of 0. For another example, if a green color hue group 204 is at the bottom of the chart it may have a corresponding color hue parameter of 180. Color hues that are complimentary may be on opposite sides of the chart and may have color hue parameters that vary by 180, for example the red-purple group 202 with a value of 0 may have a complimentary group in the green group 204 with a color hue parameter of 180.

Referring to exemplary FIG. 3, an exemplary process for creating a color palette 300 may be shown. The exemplary process 300 may begin with the user being sent a color sensing device in step 302. In other embodiments the user may use their own color sensing device, or travel to a location such as a store to have a color reading taken. The color sensing device may be, for example, the Nix mini, the Color Muse, or any other device known in the art, and may be able to detect colors and break the color down into its numerical components, for example, into its hue, chroma, and/or value numbers, or by using a color space system such as the international commission on illumination's LAB (CIELAB) color coordinates. In a next step 304 the user may take a plurality of color readings of their fixed colors. The user may be instructed to take color readings of each of a number of fixed colors, for example but not limited to, skin, hair, or eyes. The user may be instructed to take, for example, 3-9 readings of each fixed color, though in other exemplary embodiments they may take fewer or more readings. In an alternative embodiment color readings may be taken directly from a phone or computer screen if the screen is able to sufficiently capture and display the user's fixed colors to a high degree of accuracy.

In a next step 306 one or more user match colors may be determined. In an exemplary embodiment user match colors may be determined by, for example, combining or averaging numerical CIELAB or LCh color space parameters. In an exemplary embodiment the L, C, and H parameters may be recorded, for example in a spreadsheet, and deviations may be discarded. For example, deviations corresponding to secondary colors in the user's hair. In some embodiments the deviations may instead be incorporated into or used to create a secondary color palette. The secondary color palette may be, for example, used in conjunction with the primary color palette in order to determine clothing pattern recommendations, or for selecting accessories. A deviation may be, for example, any value outside a predetermined range, or outside a threshold standard deviation. One user match color may be determined, or multiple user match colors may be determined by, for example, finding an exact numerical match for each of the user's fixed color readings or by combining color readings for different combinations of the user's fixed color readings. User match colors may further include a variance allowance range for one or more of their parameters, for example, a variance allowance of +/−10. In an exemplary embodiment the fixed colors may be evaluated independently, and a different user match color may be provided for each fixed color. In a next step 308 color harmony colors may be determined by, for example, taking one or more user match colors and varying one or more parameter (e.g., value) while keeping the rest of their parameters the same (e.g., chroma and hue). Complimentary colors may be determined by, for example, taking a user match number and keeping chroma the same while changing the hue and value to the opposite (I.E. a hue of 39 would become 219 or a hue of 58 would become 238 and a value of 15 would become 85). Other color harmonies may be determined by, for example, drawing a line or a curve defined by a pattern (e.g., up 10 value units and over 10 degrees of hue angle) between the fixed colors or through a fixed color in the color space. All colors on this line or curve may also be defined as color harmonies when used together in a palette. In a final step 312 a completed color palette of numerical values, including user match color(s) and/or color harmony colors, such as complimentary colors, with or without color swatches, may be sent to the user.

In other exemplary embodiments more than three parameters may be used, and other categories in addition to user match color(s) and color harmony colors, such as complimentary colors, may be determined.

Referring to exemplary FIG. 4, an exemplary user match guide 400 may include one or more visuals of user match colors 402. In an exemplary embodiment user match colors may be surrounded by a bolded border or otherwise emphasized. The user match guide 400 may further include a number of parameters, for example, there may be a value or luminance parameter 404 which may be denoted by L, there may be a chroma parameter 406 which may be denoted by C, and there may be a hue parameter 408 which may be denoted by h. Each parameter may be followed by a numerical value defining that parameter, and further may include a tolerance range 410, which may be, for example, +/−10. It may be understood that the letters used are exemplary only, and any letter or other indication symbol may be used.

Referring to exemplary FIG. 5 an exemplary color harmony guide 500 may show one or more user match colors 502, which may be denoted by a bolded border, or emphasized in some other way. The color harmony guide 500 may further include one or more example harmony colors 504 for each of the exact match colors 502. The color harmony guide 500 may further show some or each possible parameter numbers for harmony colors 506, and may furthermore, for example, use a dash or other symbol to signify that any numerical value, within the range of relevant values, may be used for that parameter. The color harmony guide 500 may further show one or more example complimentary colors 508 for each of the one or more exact match colors 502. The color harmony guide 500 may further show the complimentary parameter numbers 510 for each of the one or more example complimentary numbers 508.

Referring to exemplary FIG. 6 an exemplary fringe color guide 600 may show one or more fringe parameter number ranges 602 for each of the one or more exact color matches. For example, if the exact match color is L:55, C:28, and h:39, then each number that has an L:55, but a number other than 28 for C and a number other than 39 for h would be a fringe match.

Referring to exemplary FIG. 7, another exemplary color match guide 700 may show an example of the user's fixed color 702. The fixed color may be, for example, a skin color or a hair color. The color match guide 700 may further include a plurality of categories, for example perfect matches 704, hue & chroma color harmony 706, hue and value color harmony 708, value & chroma color harmony 710, and/or complementary colors 712. The perfect match 704 may have an L, C, and H value that matches the fixed color 702. Each of the categories may have one or more of a value 714, chroma 716, and/or hue 718 parameter. Some embodiments the color match guide 700 may further include exemplary color swatches 720 that match the one or more parameters for each of the categories.

In an exemplary embodiment the user match guide and color harmony guide may make up a personalized color palette. The personalized color palette may indicate to the user how well their fixed colors correspond to other colors, while avoiding the use of generic classification systems such as, for example, seasonal classifications.

It may be understood that a color that has parameter values that do not fall within any of the exact match or color harmony color groups may be considered a non-matching color; and, in an exemplary embodiment, the user may be instructed to avoid non-matching colors when possible. In some embodiments non-matching colors may be used for other purposes.

In an exemplary embodiment, the parameter numbers received by the user may correspond to color swatches or listed values used in stores or may be used to match with clothing by taking color readings on clothing and matching it to the user's color palette. In some embodiments the user may use a device that records the user's parameter values, and is able to scan or otherwise identify one or more items, which may be, for example, pieces of clothing, fabric, accessories, etc. The device may then be able to output one of a plurality of outputs to the user, for example the device may determine that the scanned clothing, fabric, accessory, etc. is a “good match” or a “bad match” or may give a numeral rating or otherwise indicate how well the scanned item compliments the user's color matches. The device may give a recommendation from among the scanned items, for example recommending a best match.

In some embodiments, the color readings of a plurality of users may be recorded and stored. Collected or stored color readings may be used by, for example but not limited to, textile manufacturers, retailers, or designers, and may be used for purposes such as but not limited to informing manufacturing, marketing, or retail analysis. In some embodiments, retailers or other sellers may list color reading numbers of items for sale in order to assist shoppers in picking items that work best for them.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for analyzing and creating a color palette, comprising:
taking one or more user fixed color readings;
breaking down the fixed color readings into numerical components;
determining at least one user match color based on the fixed color readings numerical components;
determining at least one harmony color for each of the at least one match colors by varying at least one numerical component reading of the user match color;
assembling the at least one user match color and at least one harmony color into a personalized user color palette.

2. The method for analyzing and creating a color palette of claim 1, wherein taking the one or more user fixed color readings further comprises using a color sensing device to sense one or more of the user's hair color, skin color, eye color.

3. The method for analyzing and creating a color palette of claim 2, wherein before determining the at least one user match color, the fixed color ratings are recorded and any that are more than a predetermined threshold outside of the average value are discarded.

4. The method for analyzing and creating a color palette of claim 1, wherein the one or more user fixed color readings are obtained from a photo on a digital display.

5. The method for analyzing and creating a color palette of claim 2, wherein the one or more fixed color readings are at least 3 color readings of each of hair color, skin color, and eye color.

6. The method for analyzing and creating a color palette of claim 2, wherein breaking down the fixed color readings into numerical components comprises, breaking down the sensed user fixed colors into at least a hue number, a chroma number, and a value number.

7. The method for analyzing and creating a color palette of claim 1, further comprising:
determining at least one complimentary color for each user match color by varying at least one numerical component to be opposite the numerical component of the user match color;
wherein the color palette includes at least one complimentary color.

8. The method for analyzing and creating a color palette of claim 7, wherein the complimentary color for each user match color has a hue and value opposite the corresponding match color.

9. The method for analyzing and creating a color palette of claim 1, further comprising matching the color palette with at least one color swatch for each of the at least one user match color or harmony color.

10. The method for analyzing and creating a color palette of claim 6, wherein the personalized color palette displays at least the corresponding hue number, chroma number, and value number for each color.

11. The method for analyzing and creating a color palette of claim 10, wherein the personalized color palette further includes a tolerance range or margin of error for each of the at least hue number, chroma number, and value number for each color.

12. The method for analyzing and creating a color palette of claim 1, further comprising determining at least one fringe color for each of the at least one match colors by varying at least two numerical component readings of the user match color, wherein the personalized user color palette includes at least one fringe color.

13. A non-transitory computer implemented method for analyzing and creating a color palette, comprising:
taking one or more user fixed color readings;
breaking down the fixed color readings into numerical components;
determining at least one user match color based on the fixed color readings numerical components;
determining at least one harmony color for each of the at least one match colors by varying at least one numerical component reading of the user match color;
determining at least one fringe color for each of the at least one match colors by varying at least two numerical component readings of the user match color;
assembling the at least one user match color, at least one harmony color, and at least one fringe color into a user color palette.

14. A method for analyzing and creating a color palette, comprising:
taking one or more user fixed color readings;
breaking down the fixed color readings into numerical components;
determining at least one user match color based on the fixed color readings numerical components and/or determining at least one harmony color for each of the at least one match colors by varying at least one numerical component reading of the user match color;
assembling the at least one user match color or at least one harmony color into a personalized user color palette.
